(19) United States
(12) Patent Application Publication
(10) Pub. No.: US 2018/0082535 A1
(43) Pub. Date: Mar. 22, 2018

(54) GAMING SYSTEM AND METHOD PROVIDING A PHYSICS-BASED GAME INCLUDING OBJECTS THAT HAVE GAMEPLAY-ALTERING FEATURES

(71) Applicant: IGT, Las Vegas, NV (US)

(72) Inventors: Cameron Filipour, Las Vegas, NV (US); Bryan Upton, Hertfordshire (GB)

(21) Appl. No.: 15/273,065

(22) Filed: Sep. 22, 2016

(51) Int. Cl. G07F 17/32

(52) U.S. Cl. CPC G07F 17/3267; G07F 17/3213; G07F 17/3225; G07F 17/3241; G07F 17/3286; G07F 17/3244; G07F 17/3209

(57) ABSTRACT

The gaming systems and methods of the present disclosure improve gaming technology and solve the above-described problem by providing a physics-based game including objects that have gameplay-altering features. Instead of acting conventionally when used for a play of the physics-based game, these objects may act unconventionally to alter an aspect of gameplay (as compared to gameplay without objects having gameplay-altering features). Because the objects may act unconventionally, player interactivity increases, and the gaming system emphasizes sound player decision-making: players must now account for the (possible) unconventional actions of the objects when making gameplay decisions like how to bet, which objects to pick, or where to release those objects.

### COPYRIGHT NOTICE

A portion of this patent document contains material subject to copyright protection. The copyright owner does not object to photocopy reproduction of the patent document in the form it appears in the U.S. Patent and Trademark Office records, but otherwise reserves all copyright rights.

### BACKGROUND

Electronic gaming machines (EGMs) operable to enable play of wagering games are well known. A typical wagering game includes a primary game, and certain wagering games also include a bonus game.

Generally, these EGMs initiate a play of the primary game following: (1) receipt of a wager input (such as an actuation of a wager button) that indicates how much the player desires to wager; and (2) receipt of a game initiation input (such as an actuation of a play button). Many of these EGMs determine any primary awards for a wagered-on play of the primary game based on the outcome of the play of the primary game and the wager amount. Typically, the larger the wager amount, the larger the primary award (for the same outcome). Winning outcomes that are less likely to occur usually result in larger primary awards than winning outcomes that are more likely to occur.

EGMs operable to enable play of a bonus game usually initiate a play of the bonus game upon an occurrence of a bonus triggering event. These EGMs determine any bonus awards for the play of the bonus game based on the outcome of the play of the bonus game and the wager amount.

Some known physics-based primary games and bonus games rely in whole or in part on the laws of physics (or simulated laws of physics) to generate an outcome. For instance, the outcome of a play of roulette is based on movement of a ball on the roulette wheel and the outcome of a play of craps is based on movement of thrown dice. In another example, some physics-based games involve introducing objects into a virtual board including an array of pegs interspersed with award pockets. As (simulated) gravity pulls the objects through the array of pegs, the objects collide with the pegs and change direction, speed, and/or rotation as a result. Each object either falls into an award pocket, in which case the player wins the corresponding award, or exits the bottom of the virtual board, in which case the player doesn't win an award for that object.

Gaming technology for physics-based games has stagnated. While physics-based game developers have refreshed existing physics-based games with new themes or bet types, they haven't developed any features that change the games' dynamics in a way that invigorates existing players and entices new players to try physics-based games. There is a continuing need to develop new and improved physics-based gaming technology that solves this problem.

### SUMMARY

The gaming systems and methods of the present disclosure improve gaming technology and solve the above-described problem by providing a physics-based game including objects that have gameplay-altering features. Instead of acting conventionally when used for a play of the physics-based game, these objects may act unconventionally to alter an aspect of gameplay (as compared to gameplay without objects having gameplay-altering features). Because the objects may act unconventionally, player interactivity increases, and the gaming system emphasizes sound player decision-making: players must now account for the (possible) unconventional actions of the objects when making gameplay decisions like how to bet, which objects to pick, or where to release those objects.

In one embodiment, the physics-based game is a falling-object game. The falling-object game is associated with multiple objects that have different gameplay-altering features (or combinations of gameplay-altering features) that may alter gameplay when the objects are used for a play of the falling-object game (as compared to gameplay without objects having gameplay-altering features). Some gameplay-altering features are always active when the objects having those gameplay-altering features are used for a play of the falling-object game. For instance, one object has an always-active gameplay-altering bounce feature that causes that object to bounce higher off of obstacles than objects that don't have that gameplay-altering feature. Other gameplay-altering features are activated responsive to an occurrence of an activation event. Different gameplay-altering features may be associated with different activation events. For instance, the gaming system activates a gameplay-altering destruction feature of an object responsive to the object contacting an obstacle, which causes the object to destroy the obstacle.

In this embodiment, the gaming system initiates a play of the falling-object game and displays an obstacle and award area including multiple obstacles and multiple awards. The gaming system picks an object of a player set of objects (such as responsive to a player's selection of one of multiple objects the player has accumulated) and introduces the picked object into the obstacle and award area. The gaming system displays the picked object moving within the obstacle and award area as if being pulled by gravity and in accordance with any active gameplay-altering features of the picked object. After introducing the picked object into the obstacle and award area, the gaming system monitors for an occurrence of an award event, an occurrence of an activation event (if applicable for any gameplay-altering features of the picked object), and an occurrence of an exit event.

Responsive to an occurrence of the award event, such as the picked object colliding with an award displayed in the obstacle and award area, the gaming system determines and provides an award. Responsive to an occurrence of the activation event, the gaming system activates the corresponding gameplay-altering feature of the picked object. Responsive to an occurrence of the exit event, the gaming system removes the picked object from the obstacle and award area and determines whether a termination event occurred. If so, the gaming system ends the play of the falling-object game, but if not the gaming system picks another object (such as responsive to a player's selection of one of multiple objects the player has accumulated) to introduce into the obstacle and award area.

Additional features and advantages are described in, and will be apparent from, the following Detailed Description and the Figures.

### BRIEF DESCRIPTION OF THE FIGURES

FIG. 1 illustrates a flowchart of an example process or method of operating a gaming system of the present disclosure to provide an example physics-based falling-object game including objects that have gameplay-altering features.

FIGS. 2A-2L illustrate screen shots of one example embodiment of a gaming system operating an example wagering game having a primary game and a bonus physics-based falling-object game including objects that have gameplay-altering features.

FIG. 3 is a schematic block diagram of one embodiment of a network configuration of the gaming system of the present disclosure.

FIG. 4 is a schematic block diagram of an example electronic configuration of the gaming system of the present disclosure.

FIGS. 5A and 5B are perspective views of example alternative embodiments of the gaming system of the present disclosure.

### DETAILED DESCRIPTION

The gaming systems and methods of the present disclosure improve gaming technology and solve the above-described problem by providing a physics-based game including objects that have gameplay-altering features. Instead of acting conventionally when used for a play of the physics-based game, these objects may act unconventionally to alter an aspect of gameplay (as compared to gameplay without objects having gameplay-altering features). Because the objects may act unconventionally, player interactivity increases, and the gaming system emphasizes sound player decision-making: players must now account for the (possible) unconventional actions of the objects when making gameplay decisions like how to bet, which objects to pick, or where to release those objects.

The Detailed Description uses numbered headings for clarity. These headings do not limit the scope of the present disclosure

### 1. Example Method for a Physics-Based Falling-Object Game

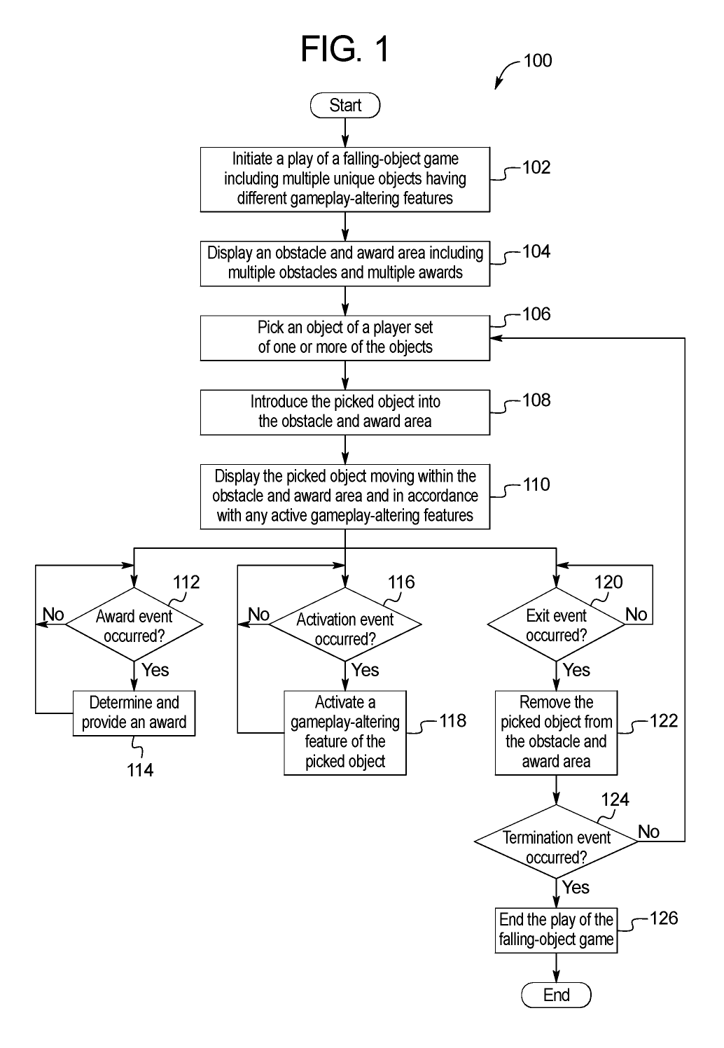

FIG. 1 illustrates a flowchart of an example process or method 100 of operating a gaming system of the present disclosure to provide an example physics-based falling-object game including objects that have gameplay-altering features. In various embodiments, a set of instructions stored in one or more memories and executed by one or more processors represents the process 100. Although the process 100 is described with reference to the flowchart shown in FIG. 1, many other processes of performing the acts associated with the process 100 may be employed. For example, the order of certain of the illustrated blocks or diamonds may be changed, certain of the illustrated blocks or diamonds may be optional, or certain of the illustrated blocks or diamonds may not be employed.

In operation of this example embodiment, the process 100 begins and the gaming system initiates a play of the falling-object game, as block 102 indicates. The falling-object game includes multiple unique objects, each of which has one or more of multiple different gameplay-altering features. A gameplay-altering feature is a feature that alters or may, if certain conditions are satisfied, alter gameplay as compared to gameplay without the gameplay-altering feature. Some gameplay-altering features are always active when the objects having those gameplay-altering features are used for a play of the falling-object game. Other gameplay-altering features are activated responsive to an occurrence of a corresponding activation event, as explained below.

Returning to the process 100, the gaming system displays an obstacle and award area including multiple obstacles and multiple awards, as block 104 indicates. The gaming system picks an object of a player set of one or more of the objects (such as responsive to a player selection of one of the objects), as block 106 indicates, and introduces the picked object into the obstacle and award area, as block 108 indicates. The gaming system displays the picked object moving within the obstacle and award area and in accordance with any active gameplay-altering features, as block 110 indicates. After introducing the picked object into the obstacle and award area, the gaming system monitors for: (1) an occurrence of an award event, as diamond 112 indicates; (2) an occurrence of an activation event (if applicable for any gameplay-altering features of the picked object), as diamond 116 indicates; and (3) an occurrence of an exit event, as diamond 120 indicates.

Responsive to the gaming system determining at diamond 112 that the award event occurred, the gaming system determines and provides an award, as block 114 indicates. Responsive to the gaming system determining at diamond 116 that the activation event occurred, the gaming system activates the corresponding gameplay-altering feature of the picked object, as block 116 indicates. Responsive to the gaming system determining at diamond 120 that the exit event occurred, the gaming system removes the picked object from the obstacle and award area, as block 122 indicates, and determines whether a termination event occurred, as diamond 124 indicates.

If the gaming system determines at diamond 124 that the termination event occurred, the gaming system ends the play of the falling-object game, as block 126 indicates, and the process 100 ends. But if the gaming system determines at diamond 124 that the termination event did not occur, the process 100 returns to block 106.

### 2. Example Gaming System Operation for a Physics-Based Falling-Object Game

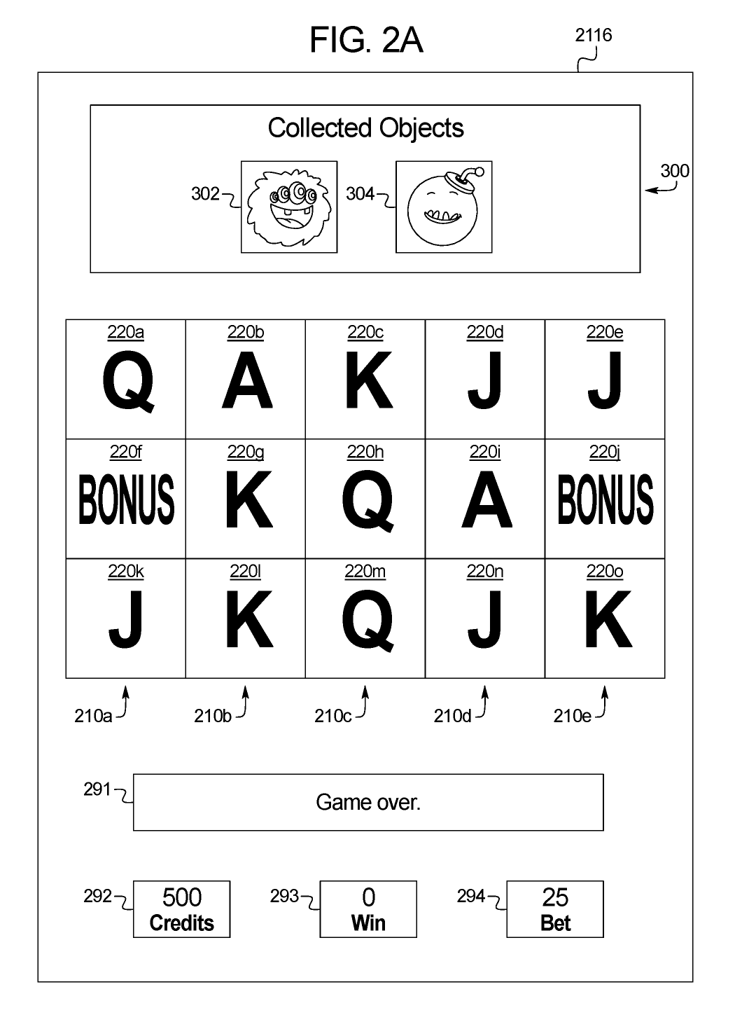

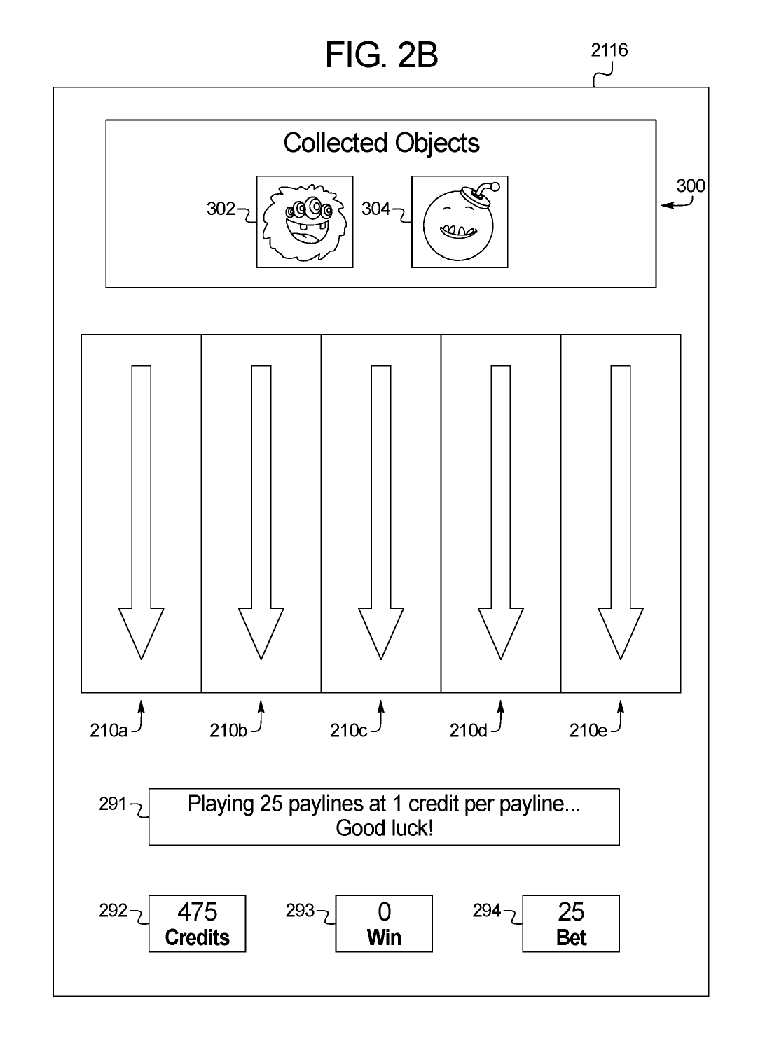

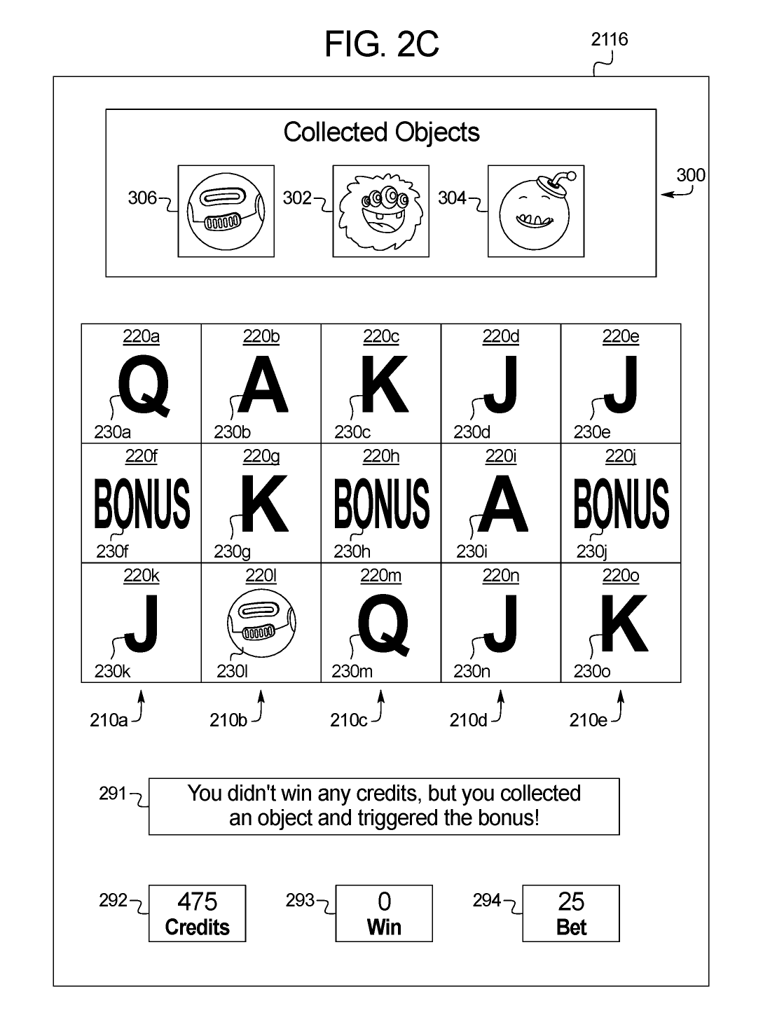

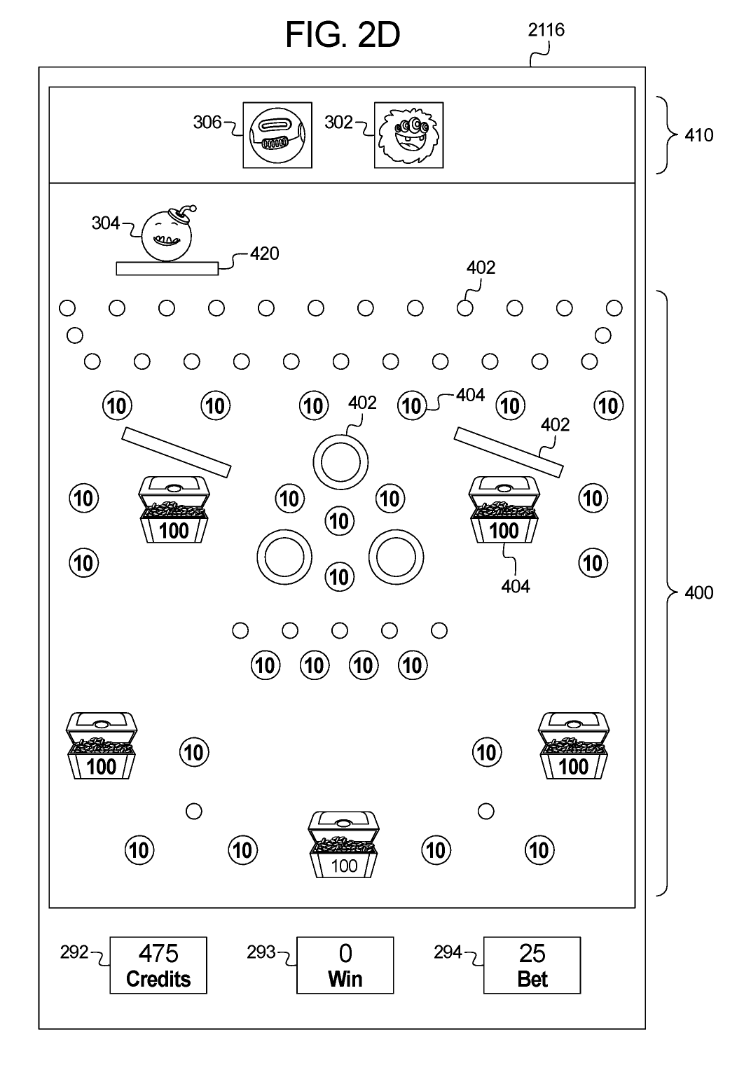

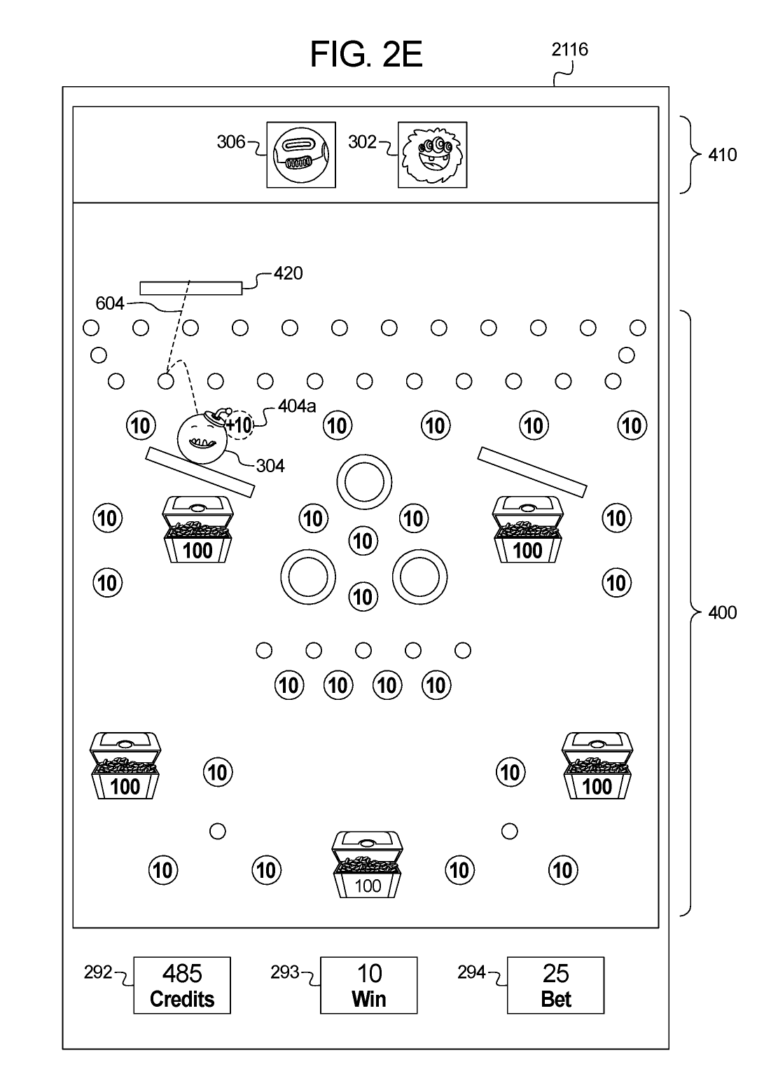

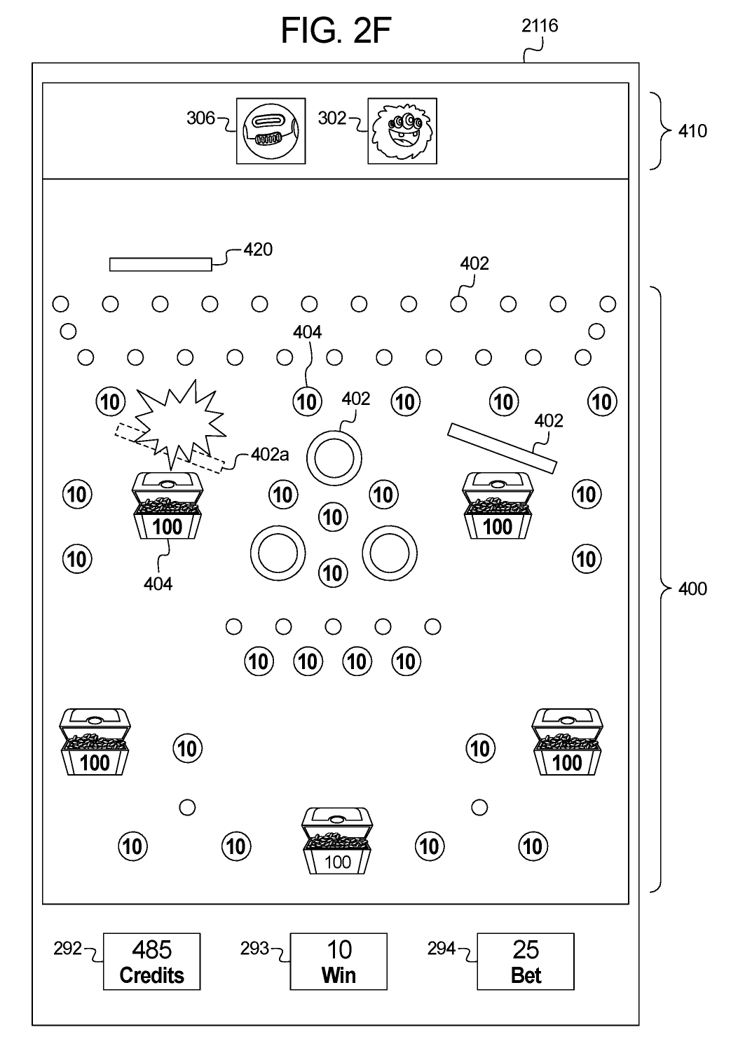

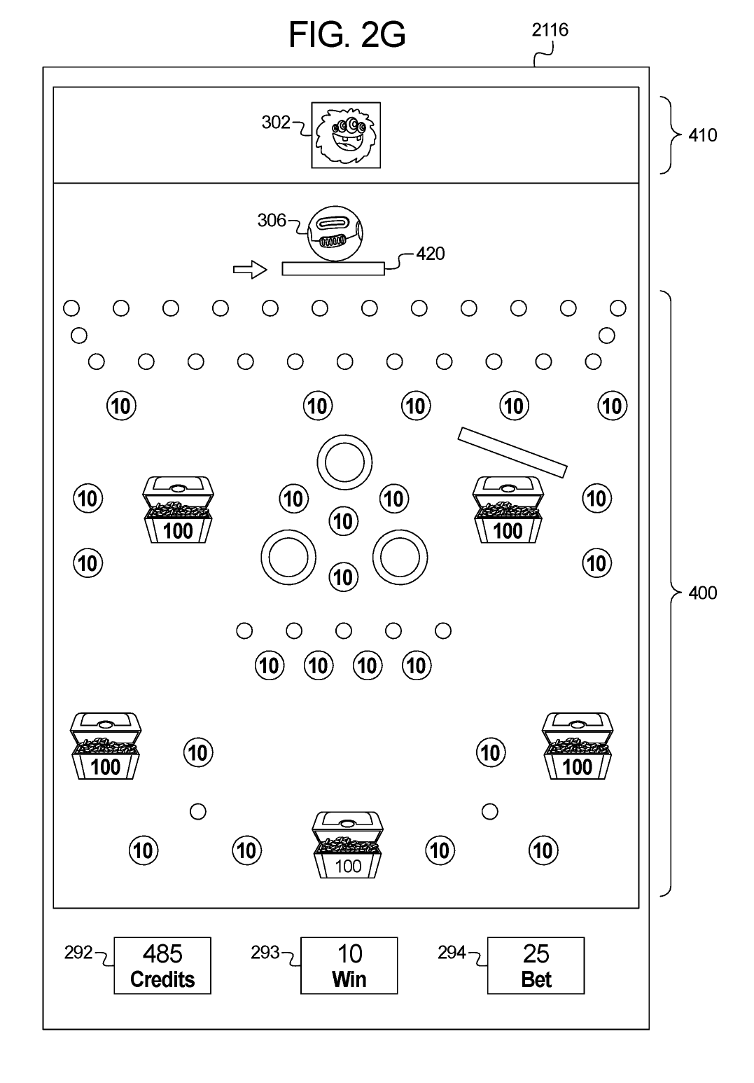

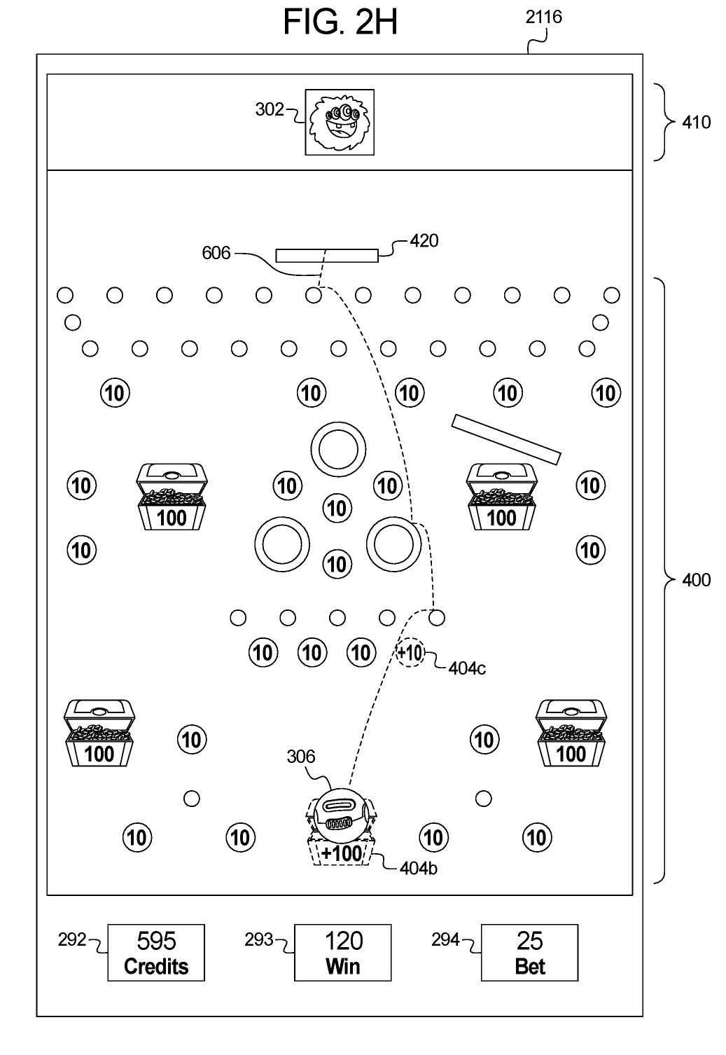

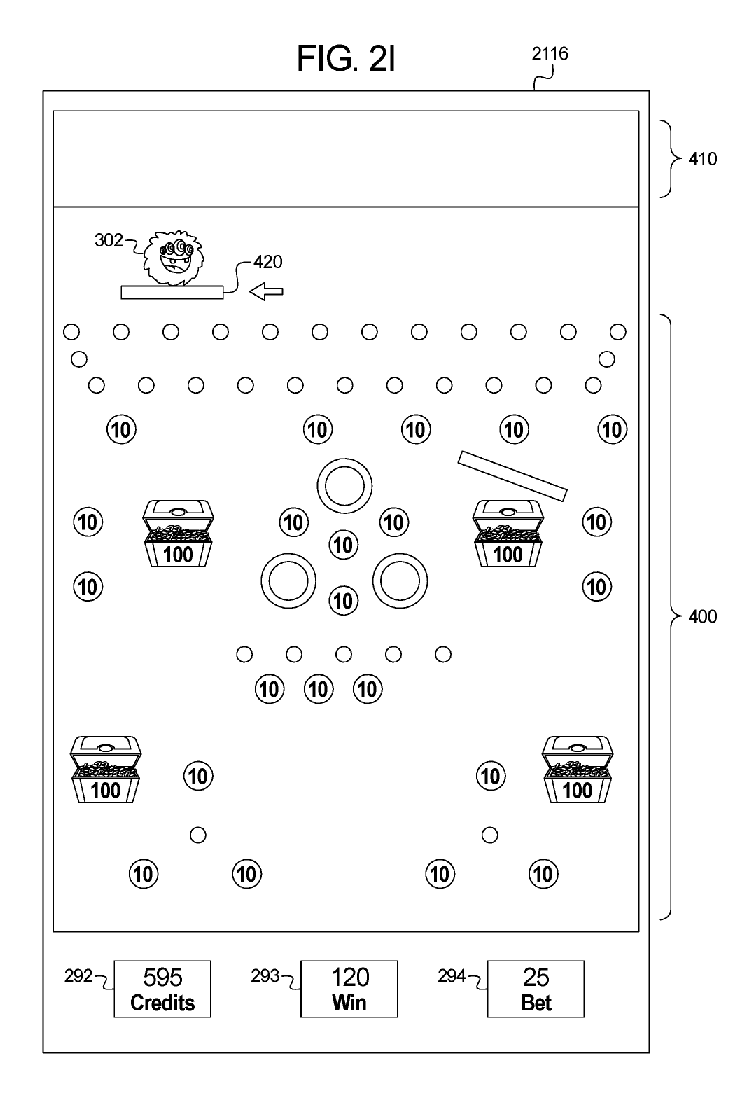

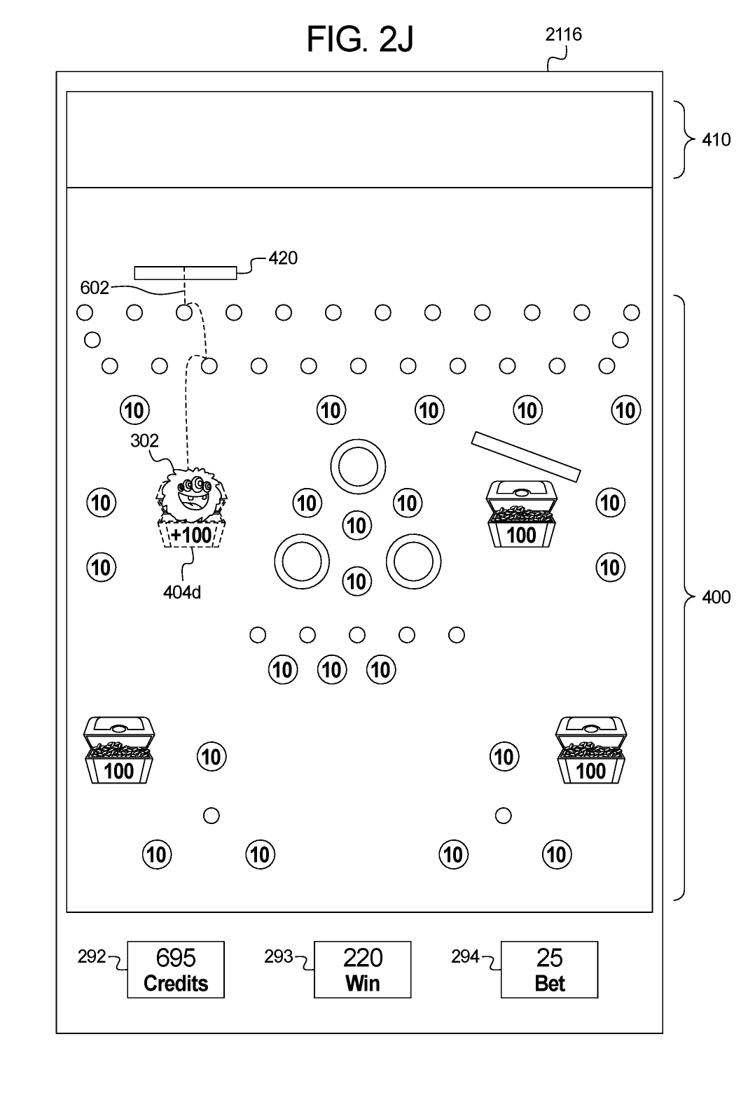

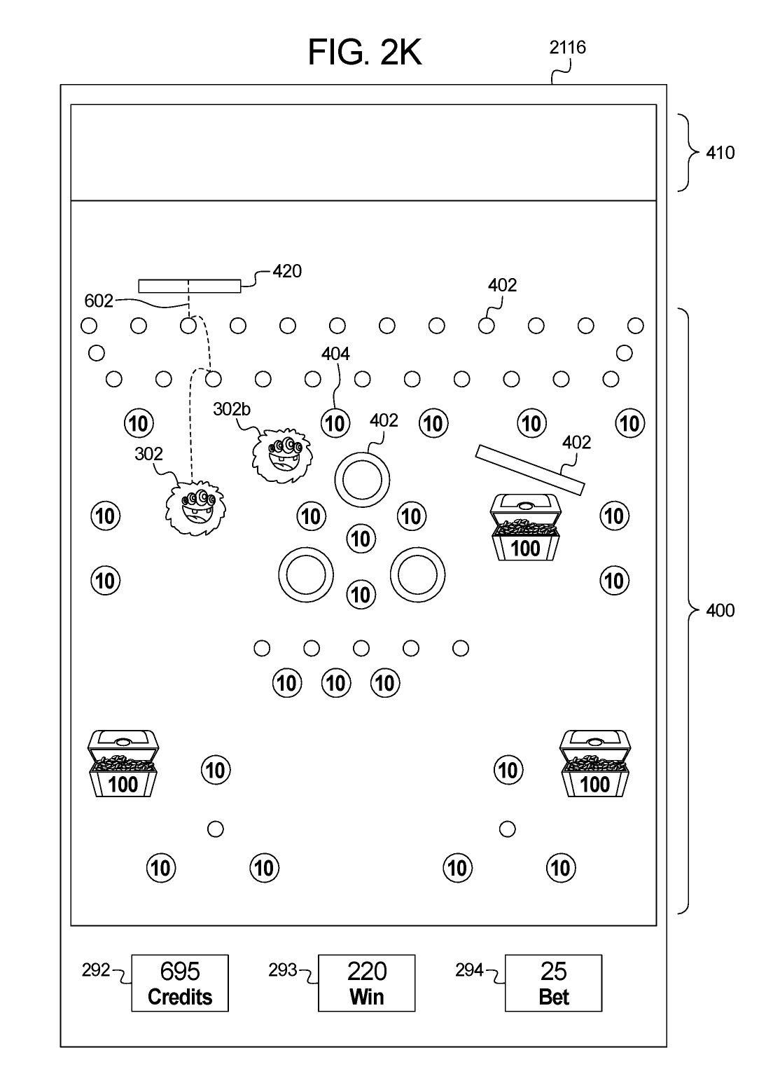

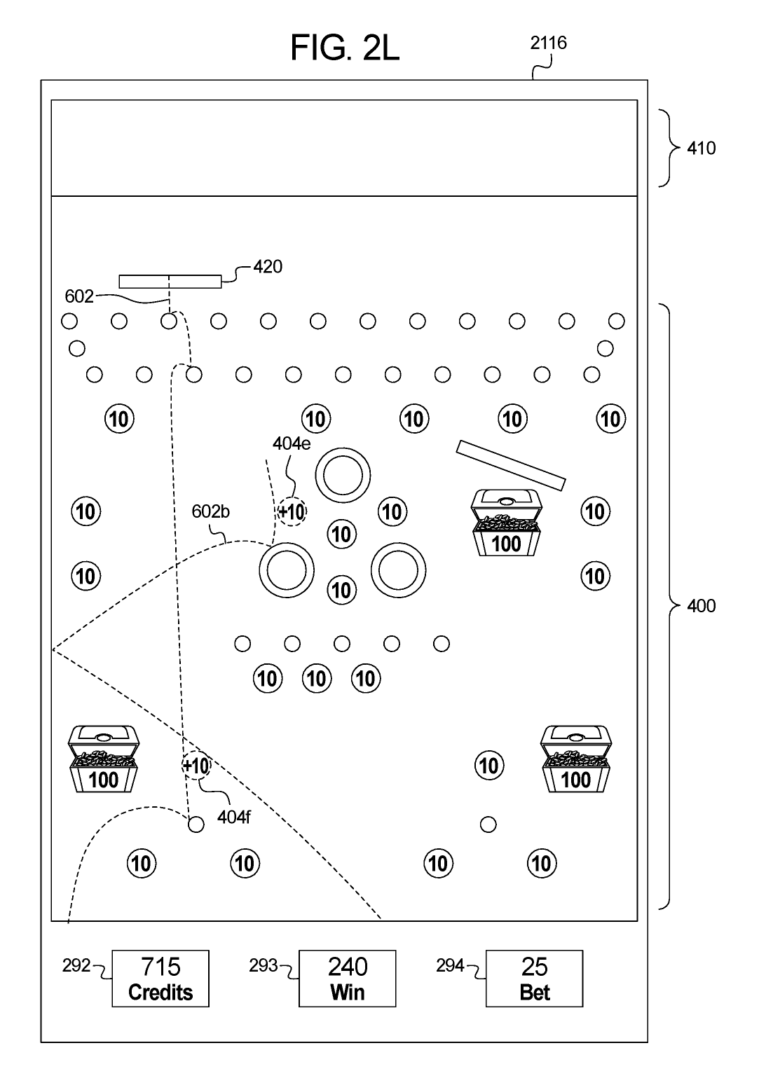

FIGS. 2A-2L illustrate screen shots of one example embodiment of a gaming system operating an example wagering game having a primary game and a bonus physics-based falling-object game including objects that have gameplay-altering features. The primary game is a reel-based game in this example embodiment, though the primary game may be any suitable type of game.

In this example embodiment, for the primary game, the gaming system displays, such as on a display device 2116 (described below), fifteen symbol display areas 220a, 220b, 220c, 220d, 220e, 220f, 220g, 220h, 220i, 220j, 220k, 220l, 220m, 220n, and 220o arranged in a 3×5 grid. The gaming system also displays five reels 210a, 210b, 210c, 210d, and 210e in association with the symbol display areas. Each reel is associated with a plurality of symbols including object symbols and non-object symbols. Each object symbol is associated with an object usable in the bonus physics-based falling object game, described below. The reels may be associated with the same pluralities of symbols or different pluralities of symbols.

Each reel is associated with and configured to display symbols at a plurality of the symbol display areas. Here: (1) the reel 210a is associated with and configured to display symbols at the symbol display areas 220a, 220f, and 220k; (2) the reel 210b is associated with and configured to display symbols at the symbol display areas 220b, 220g, and 220l; (3) the reel 210c is associated with and configured to display symbols at the symbol display areas 220c, 220h, and 220m; (4) the reel 210d is associated with and configured to display symbols at the symbol display areas 220d, 220i, and 220n; and (5) the reel 210e is associated with and configured to display symbols at the symbol display areas 220e, 220j, and 220o.

In this example embodiment, the primary game is associated with 25 paylines, which aren't shown for clarity. Each payline is associated with a different plurality of the symbol display areas. This is merely one example of a payline configuration, and other reel-based primary games may have different quantities of paylines, payline configurations, or no paylines at all (e.g., have a ways-to-win or a scatter pay award determination).

The gaming system displays a message box 291 that displays various messages before, during, or after play of the wagering game. The gaming system also displays a plurality of meters including a credit meter 292 that indicates the player's credit balance, an award meter 293 that displays any awards won for a play of the wagering game, and a bet meter 294 that displays the player's total bet for a play of the wagering game. While in this example embodiment the gaming system indicates the player's credit balance, the player's wager, and any awards in credits, the gaming system may also indicate them in amounts of currency.

In this example embodiment, the reels 210a, 210c, and 210e each include a BONUS symbol. A bonus triggering event occurs when the reels 210a, 210c, and 210e each display the BONUS symbol following a spin of the reels. The gaming system initiates a play of the bonus physics-based falling-object game responsive to the occurrence of the bonus triggering event. This is merely one example of the bonus triggering event. In other embodiments, the bonus triggering event may be any suitable event associated with or independent of the primary game, such as (but not limited to): for a primary game with a payline-based award evaluation, a particular symbol or symbol combination (such as a winning symbol combination) being displayed along a wagered-on payline; a primary game award exceeding a particular threshold; a mystery event randomly triggered independent of the primary game outcome; the primary game outcome being a designated outcome; the player having collected a particular quantity of objects (described below); or a particular symbol or symbol combination being displayed following a spin (e.g., a scatter trigger symbol or trigger symbol combination).

In this example embodiment, an object collection event occurs when an object symbol is displayed on a reel following a spin of the reels. Responsive to an occurrence of the object collection event, the gaming system collects an object associated with the displayed object symbol for the player and displays the collected object in an object collection area 300. When the bonus physics-based falling object game is triggered, the collected objects are used during gameplay. So in this example embodiment, the player collects objects to use in the bonus physics-based falling-object game through play of the primary game. There is merely one example of an object collection event. In other embodiments, the object collection event may be any suitable event associated with or independent of the primary game, such as (but not limited to): for a primary game with a payline-based award evaluation, an object symbol or symbol combination including an object symbol (such as a winning symbol combination) being displayed along a wagered-on payline; a primary game award exceeding a particular threshold; a mystery event randomly triggered independent of the primary game outcome; or the primary game outcome being a designated outcome.

Turning to FIG. 2A, at this point in time, the gaming system has completed a play of the primary game that resulted in no winning symbol combinations. Also, at this point in time, the player has collected an object 302 and an object 304. The gaming system receives an actuation of a spin button (not shown).

As illustrated in FIG. 2B, responsive to the actuation of the spin button, the gaming system places a 25 credit bet (1 credit per payline), decreases the credit balance by the 25 credit bet from 500 credits to 475 credits, initiates a play of the primary game, and displays the reels 210a-210e spinning. The gaming system displays the following message in the message box 291: “Playing 25 paylines at 1 credit per payline . . . Good luck!”

As illustrated in FIG. 2C, the gaming system stops spinning the reels 210a-210e such that: QUEEN symbol 230a is displayed at the symbol display area 220a, ACE symbol 230b is displayed at the symbol display area 220b, KING symbol 230c is displayed at the symbol display area 220c, JACK symbol 230d is displayed at the symbol display area 220d, JACK symbol 230e is displayed at the symbol display area 220e, BONUS symbol 230f is displayed at the symbol display area 220f, KING symbol 230g is displayed at the symbol display area 220g, BONUS symbol 230h is displayed at the symbol display area 220h, ACE symbol 230i is displayed at the symbol display area 220i, BONUS symbol 230j is displayed at the symbol display area 220j, JACK symbol 230k is displayed at the symbol display area 220k, OBJECT symbol 230l is displayed at the symbol display area 220l, QUEEN symbol 230m is displayed at the symbol display area 220m, JACK symbol 230n is displayed at the symbol display area 220n, and KING symbol 230o is displayed at the symbol display area 220o.

The gaming system determines any awards associated with the symbols 230a-230o displayed at the symbol display areas 220a-220o by determining, for each wagered-on payline and based on a primary game paytable (not shown), whether any winning combinations of the symbols are displayed at the symbol display areas associated with that particular payline. In this instance, the gaming system determines that, for each of the 25 wagered-on paylines, no winning symbol combination is displayed at the symbol display areas associated with that particular payline. Accordingly, the gaming system doesn't determine any awards for the play of the primary game.

The gaming system determines that the object collection event occurs since the OBJECT symbol 230l is displayed on the reel 210b following a spin of the reels. Accordingly, the gaming system collects an object 306 associated with the OBJECT symbol 230l for the player and displays the collected object in the object collection area 300.

The gaming system also determines that the bonus triggering event occurs because the reel 210a displays the BONUS symbol 230f, the reel 210c displays the BONUS symbol 230h, and the reel 210e displays the BONUS symbol 230j post-spin. The gaming system displays the following message in the message box 291: “You didn't win any credits, but you collected an object and triggered the bonus!”

Responsive to the occurrence of the bonus triggering event, the gaming system initiates a play of the bonus physics-based falling-object game. As shown in FIGS. 2D-2L, the gaming system displays an obstacle and award area 400 including obstacles 402 and awards 404. For clarity, not all obstacles and awards are labeled. Each award 404 is associated with a value, here 10 credits or 100 credits. The gaming system displays an object queuing area 410 in which the gaming system displays the player's collected objects. The gaming system also displays an object release area 420.

As explained above, the gaming system uses objects the player has collected during primary game play for the bonus physics-based falling-object game. Each object has one or more of multiple different gameplay-altering features. Some gameplay-altering features are always active when the objects having those gameplay-altering features are used for a play of the falling-object game. Other gameplay-altering features are activated responsive to an occurrence of a corresponding activation event.

In this example embodiment, the object 302 has a gameplay-altering multiply feature that the gaming system activates responsive to an occurrence of a first activation event. The first activation event occurs when the object 302 collides with an award in the obstacle and award area 400. Activation of the multiply feature causes the gaming system to spawn another object in the obstacle and award area 400. In this example embodiment, the object 304 has a gameplay-altering destroy feature that the gaming system activates responsive to an occurrence of a second activation event. The second activation occurs at a random point in time following release of the object 304 into the obstacle and award area 400. Activation of the destroy feature causes the gaming system to remove the object 304 and the obstacle closest to the object 304 from the obstacle and award area 400. In this example embodiment, the object 306 has a gameplay-altering award-seeking feature that's active upon release of the object 306 into the obstacle and award area 400. The award-seeking feature causes the object 306 to seek out and collide with the most difficult-to-obtain award in the obstacle and award area 400. That is, use of this object guarantees that the gaming system will provide the player the most difficult-to-obtain award.

Generally, for a play of the bonus physics-based falling-object game in this example embodiment, the gaming system: (1) enables the player to pick one of the objects from the object queuing area 410 to release; (2) displays the picked object in the object release area 420; (3) enables the player to move the object release area 420 from side to side to a desired position; and (4) releases the picked object from the object release area 420 and into the obstacle and award area 400 responsive to receipt of a release input.

After release, the picked object falls through the obstacle and award area 400 as if pulled by gravity, colliding with obstacles 402 and possibly colliding with awards 404, until an exit event occurs, at which point the gaming system removes the picked object from the obstacle and award area 400. In this embodiment, the exit event occurs for a released picked object when that released picked object reaches the bottom of the obstacle and award area 400. The gaming system removes a picked object from the obstacle and award area 400 responsive to the exit event occurring for the picked object. When the picked object collides with one of the obstacles 402 (i.e., when the perimeter of the picked object touches or intersects with the perimeter of one of the obstacles 402), the picked object may change direction and/or speed. This occurs because the obstacles 402 are immovable in this embodiment. According to the laws of physics, since the obstacles 402 don't move when the picked object collides with them, the picked object must change direction, speed, or both.

The gaming system determines how each picked object moves through the obstacle and award area 400 based (at least in part) on the player's inputs, such as which obstacle is being released and where the gaming system will release it. More specifically, the gaming system determines at least: (1) which obstacles 402 the picked object will collide with while moving through the obstacle and award area 400; (2) which awards 404 (if any) the picked object will collide with while moving through the obstacle and award area 400; (3) how the picked object's movement will change responsive to collisions with obstacle or awards; (4) how and when any features of the picked object will activate; and (5) where and how the picked object will exit the obstacle and award area 400. Put differently, the gaming system determines an object path in which the picked object: (1) begins at the object release area 420; (2) collides with one of more of the obstacles 402 and zero, one, or more than one of the awards 404 while moving through the obstacle and award area 400; and (3) exits the obstacle and award area 400.

The gaming system may determine the object path in one of multiple different suitable ways, depending on the embodiment. In this embodiment, the gaming system dynamically generates the object path while the picked object is moving through the obstacle and award area using a physics engine, such as described in U.S. Pat. No. 7,826,419, which is incorporated herein by reference. The physics engine may take any suitable factors into account when generating the object path, such as (but not limited to) the locations, sizes, shapes, and other characteristics of the obstacles; the release point of the picked object; the active or activatable feature(s) of the picked object; the size and shape of the picked object; the locations of the awards; and/or characteristics of the obstacle and award area (e.g., obstacle movement inhibition characteristics).

In this example embodiment, a termination event occurs responsive to the gaming system removing the last of the player's objects from the obstacle and award area 400. The gaming system ends the play of the bonus physics-based falling-object game responsive to the occurrence of the termination event.

Turning to FIG. 2D, the gaming system received a selection of the object 304 and, in response, displays the object 304 in the object release area 420. Responsive to receipt of a release input, the gaming system releases the object 304 from the object release area 420 into the obstacle and award area 400. As shown in FIG. 2E, the object 304 moves along a path 604 through the obstacle and award area 400 and collides with an award 404a. In response, the gaming system provides the player a 10 credit award, increases the credit and win meters 292 and 293 accordingly, and removes the award 404a from the obstacle and award area 400.

As shown in FIG. 2F, shortly thereafter the gaming system randomly determines to activate the gameplay-altering destroy feature of the object 304. As shown in FIG. 2G, activation of the destroy feature causes the gaming system to remove the object 304 and the obstacle closest to the object 304—which here is obstacle 402a—from the obstacle and award area 400.

As also shown in FIG. 2G, the gaming system received a selection of the object 306 and, in response, displays the object 306 in the object release area 420. Responsive to receipt of a release input, the gaming system releases the object 306 from the object release area 420 into the obstacle and award area 400. As indicated above, the object 306 has a gameplay-altering award-seeking feature that's active upon release of the object 306 into the obstacle and award area 400. The award-seeking feature causes the object 306 to seek out and collide with the most difficult-to-obtain award in the obstacle and award area 400. Accordingly, as shown in FIG. 211, the gaming system determines that an award 404b is the most difficult-to-obtain award, and causes the object 306 to move along a path 606 through the obstacle and award area 400 to collide with the award 404b. Along the way, the object 306 also collides with an award 404c. In response, the gaming system provides the player a 100 credit award (for the award 404b) and a 10 credit award (for the award 404c), increases the credit and win meters 292 and 293 accordingly, and removes the awards 404b and 404c from the obstacle and award area 400. Once the object 306 reaches the bottom of the obstacle and award area 400, the gaming system determines that the exit condition is met and removes the object 306 from the obstacle and award area 400 (not shown).

As shown in FIG. 21, the gaming system received a selection of the object 302 (or, since the object 302 is the last-remaining object in the object queuing area 410, automatically selects the object 302) and, in response, displays the object 302 in the object release area 420. As indicated above, the object 306 has a gameplay-altering multiply feature that the gaming system activates responsive to the object 302 colliding with an award in the obstacle and award area 400. Activation of the multiply feature causes the gaming system to spawn another object in the obstacle and award area 400.

As shown in FIG. 2J, responsive to receipt of a release input, the gaming system releases the object 302 from the object release area 420 into the obstacle and award area 400. The object 302 moves along a path 602 through the obstacle and award area 400 and collides with an award 404d. In response, the gaming system provides the player a 100 credit award, increases the credit and win meters 292 and 293 accordingly, and removes the award 404d from the obstacle and award area 400.

As shown in FIG. 2K, also responsive to the object 302 colliding with the award 404d, the gaming system spawns another object 302b within the obstacle and award area 400. The spawned object 302b doesn't have any gameplay-altering features in this example embodiment, and the gameplay-altering multiply feature can't occur again for the object 302.

As shown in FIG. 2L, the object 302 moves through the obstacle and award area 400 along a path 602 and the object 302b moves through the obstacle and award area 400 along a path 602b until the gaming system removes them from the obstacle and award area 400. Along the way, the object 302 collides with an award 404e and the object 302b collides with an award 404f. In response, the gaming system provides the player a 10 credit award (for the award 404e) and a 10 credit award (for the award 4040, increases the credit and win meters 292 and 293 accordingly, and removes the awards 404e and 404f from the obstacle and award area 400.

At this point, the termination event occurs because the gaming system has removed the last of the player's objects from the obstacle and award area 400. The gaming system ends the play of the bonus physics-based falling-object game responsive to the occurrence of the termination event.

### 3. Variations

An object may have any suitable gameplay-altering feature such as, but not limited to:
a multiply feature that, when activated responsive to an activation event, causes the gaming system to spawn one or more additional objects;
a destroy feature that, when activated responsive to an activation event, causes the gaming system to destroy one or more obstacles (such as those within a particular vicinity of the object or those having a particular characteristic) with or without destroying the object;
an award-seeking feature that, when active, causes the object to seek out and collide with an award, such as the most difficult-to-obtain award, the highest award, or a player-selected award;
an obstacle-avoiding feature that, when active, causes the object to avoid one or more obstacles;
a physics-altering feature that, when active, temporarily changes one or more the physical characteristics of the object relative to itself (e.g., its size, its (virtual) mass, its resiliency, its malleability, or its bounciness));
a feature that renders that object different from all other objects, such as having a different size, a different mass, a different bounciness, and the like;
an optimal-path feature that, when active, causes the object to take an optimal path through the object and award area, such as the path that will result in the largest collective award;
an access feature that, when active, enables the object to access otherwise blocked areas of the obstacle and award area; and/or
a speed-altering feature that, when activated, increases the speed of the object's movement for a certain period (such as a limited period or until the object is removed from the obstacle and award area).

In various embodiments, upon initiation of the physics-based falling-object game, the gaming system selects the obstacle and award area from multiple different obstacle and award areas. The obstacle and award areas are all unique, and have different themes, different types of obstacles, different types or values of awards, differently positioned obstacles, and/or differently positioned awards. In these embodiments, the player's strategy—e.g., the decision of the order in which to release the objects and the decisions where to release the objects—may vary depending on which obstacle and award area the gaming system picks.

In certain embodiments, rather than enabling the player to collect objects through primary game play, the gaming system enables the player to select a designated quantity of objects from a set of multiple objects upon initiation of the physics-based falling-object game. The gaming system may include all of the objects or a subset of the objects in the set. In some embodiments, the gaming system shows the player the obstacle and award area before enabling the player to select the player's objects. This enables the player to tailor her object selection to the particular obstacle and award area. For instance, if the player knows the obstacle and award area includes several “ice” obstacles, the player can choose “fire” objects that will melt the “ice” obstacles.

In certain embodiments, rather than enabling the player to collect objects through primary game play, the gaming system randomly determines the player's objects upon initiation of the physics-based falling-object game.

In certain embodiments, the gaming system enables multiple objects to move through the obstacle and award area at least partially concurrently.

For a given object having an activatable gameplay-altering feature, the activation event may be any suitable event such as, but not limited to: a random event, an event that occurs based on gameplay, a player input, the object colliding with an obstacle, the object colliding with an award, the object colliding with another object, or the object being released into the obstacle and award area. Different gameplay-altering features may have different activation events. For instance, the gaming system may activate a first gameplay-altering feature when an object collides with an obstacle and a second different gameplay-altering feature when the object collides with an award.

The termination event may be any suitable event such as, but not limited to: all of the player's objects being removed from the obstacle and award area; a time period expiring; or an object satisfies a termination condition, such as by colliding with a terminator or landing in a terminator pocket.

In certain embodiments, rather than include a movable object release area from which to release the picked objects, the gaming system includes a virtual launcher. The launcher includes a chute having a compressible spring and an object launch pad. To introduce an object into the obstacle and award area, the gaming system first positions the object onto the object launch pad. The gaming system enables the player to control the compression of the spring, which enables the player to control the speed at which the object travels upon leaving the object launch pad (i.e., the object launch speed). The gaming system may also or alternatively enable the player to control the object's launch direction and/or launch spin. The gaming system determines the object path based at least in part on the player-selected spring compression.

In certain embodiments, the obstacle and award area includes a player-controllable element that enables player interaction while an object is moving through the obstacle and award area. For instance, in one embodiment, the obstacle and award area includes a flipper that the player can control to attempt to modify the movement of an object (by contacting it with the flipper).

While the above description focuses on a physics-based falling-object game, the present disclosure applies to all suitable physics-based games. For example, for one embodiment of a roulette game, the ball—an object—has an activatable gameplay-altering feature that, when randomly activated, causes the ball to be more likely to land in a red pocket (than a black or green pocket). This affects the player's betting strategy, since she knows it's possible that the ball will gravitate toward red pockets in any given play. In another example embodiment, the physics-based game is a pinball-type game.

In another example embodiment, the physics-based game is a ring-toss game in which players attempt to virtually throw or otherwise launch rings onto targets (like bottle tops). In this embodiment, the rings can have different gameplay-altering features, like a feature that makes the target smaller (or the ring or a larger diameter) to increase the likelihood of hitting the target.

In another example embodiment, the physics-based game is a target shooting game in which players attempt to fire projectiles (e.g., arrows or bullets) at targets. In this embodiment, the projectiles can have different gameplay-altering features, like a feature that makes the projectile move faster, provides the projectile increased power so it can pass through blocking obstacles, increases the projectile's size so it can knock down obstacles or hit multiple targets, changes the way the projectile moves (e.g., biases the projectile right or left), causes the projectile to cause certain events to occur (e.g., start a target on fire or turn it to ice upon impact), or provides a spawning feature in which the projectile can split into multiple projectiles.

In another example embodiment, the physics-based game is a fishing game with physics-based casting in which the lures can have different gameplay-altering features, like wings that enable longer than normal casting, a mini-bomb feature that explodes when it hits the water, or an ice feature that freezes the water and forces fish to the surface.

In certain embodiments, one or more gameplay-altering features of an object are not indicated to the player. That is, in these embodiments, an object has one or more “mystery” gameplay-altering features.

In various embodiments, the gaming system randomly adds one or more gameplay-altering features to an object.

In certain embodiments, the gaming system enables the player to create a customized object by enabling the player to pick a designated quantity of features to attribute to an object. Some of those features may be “mystery” features whose identities aren't indicated to the player.

In certain embodiments in which an object has multiple gameplay-altering features, the gaming system activates the gameplay-altering features according to a particular order, such as a random order, a predetermined order, or a player-selected order.

In another example, in one embodiment of a pinball-type game, the ball—an object—has a gameplay-altering feature that enables that ball to access certain areas of the playfield that balls without this gameplay-altering feature can't access. This affects the player's play strategy, since she knows that only some balls can access certain areas.

The exit event may be any suitable event, such as (but not limited to) an object reaching a certain position in the obstacle and award area, the object colliding with a particular element (such as an object-destroying obstacle), or a particular time period expiring.

The present disclosure contemplates that:
(a) the occurrence of the bonus triggering event;
(b) the occurrence of an activation event;
(c) the occurrence of the termination event;
(d) the objects in the player set of objects;
(e) the quantity of objects in the player set of objects;
(f) the quantity of obstacles in the obstacle and award area;
(g) the quantity of awards in the obstacle and award area;
(h) the position of the obstacles in the obstacle and award area;
(i) the position of the awards in the obstacle and award area;
(j) an object's path through the obstacle and award area;
(k) the occurrence of the exit event;
(l) the gameplay-altering features an object has; and/or
(m) any other variables or determinations described herein

may be: (1) predetermined; (2) randomly determined; (3) randomly determined based on one or more weighted percentages (such as according to a weighted table); (4) determined based on a generated symbol or symbol combination; (5) determined independent of a generated symbol or symbol combination; (6) determined based on a random determination by a central controller (described below); (7) determined independent of a random determination by the central controller; (8) determined based on a random determination at an EGM; (9) determined independent of a random determination at the EGM; (10) determined based on at least one play of at least one game; (11) determined independent of at least one play of at least one game; (12) determined based on a player's selection; (13) determined independent of a player's selection; (14) determined based on one or more side wagers placed; (15) determined independent of one or more side wagers placed; (16) determined based on the player's wager or wager level; (17) determined independent of the player's wager or wager level; (18) determined based on time (such as the time of day); (19) determined independent of time (such as the time of day); (20) determined based on an amount of coin-in accumulated in one or more pools; (21) determined independent of an amount of coin-in accumulated in one or more pools; (22) determined based on a status of the player (i.e., a player tracking status); (23) determined independent of a status of the player (i.e., a player tracking status); (24) determined based on one or more other determinations disclosed herein; (25) determined independent of any other determination disclosed herein; or (26) determined in any other suitable manner or based on or independent of any other suitable factor(s).

### 4. Gaming Systems

The above-described embodiments of the present disclosure may be implemented in accordance with or in conjunction with one or more of a variety of different types of gaming systems, such as, but not limited to, those described below

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices.

Thus, in various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, the term “EGM” is used herein to refer to an electronic gaming machine (such as a slot machine, a video poker machine, a video lottery terminal (VLT), a video keno machine, or a video bingo machine located on a casino floor). Additionally, for brevity and clarity and unless specifically stated otherwise, “EGM” as used herein represents one EGM or a plurality of EGMs, “personal computing device” as used herein represents one personal computing device or a plurality of personal computing devices, and “central server, central controller, or remote host” as used herein represents one central server, central controller, or remote host or a plurality of central servers, central controllers, or remote hosts.

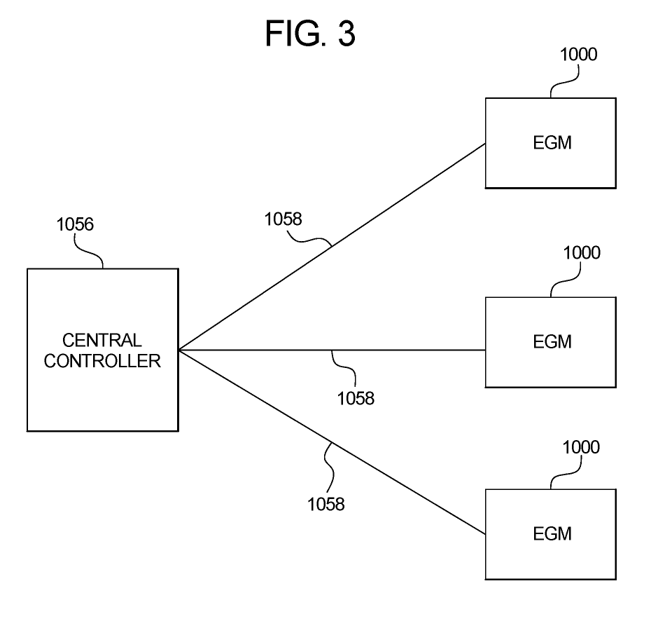

As noted above, in various embodiments, the gaming system includes an EGM (or personal computing device) in combination with a central server, central controller, or remote host. In such embodiments, the EGM (or personal computing device) is configured to communicate with the central server, central controller, or remote host through a data network or remote communication link. In certain such embodiments, the EGM (or personal computing device) is configured to communicate with another EGM (or personal computing device) through the same data network or remote communication link or through a different data network or remote communication link. For example, the gaming system illustrated in FIG. 3 includes a plurality of EGMs 1000 that are each configured to communicate with a central server, central controller, or remote host 1056 through a data network 1058.

In certain embodiments in which the gaming system includes an EGM (or personal computing device) in combination with a central server, central controller, or remote host, the central server, central controller, or remote host is any suitable computing device (such as a server) that includes at least one processor and at least one memory device or data storage device. As further described herein, the EGM (or personal computing device) includes at least one EGM (or personal computing device) processor configured to transmit and receive data or signals representing events, messages, commands, or any other suitable information between the EGM (or personal computing device) and the central server, central controller, or remote host. The at least one processor of that EGM (or personal computing device) is configured to execute the events, messages, or commands represented by such data or signals in conjunction with the operation of the EGM (or personal computing device). Moreover, the at least one processor of the central server, central controller, or remote host is configured to transmit and receive data or signals representing events, messages, commands, or any other suitable information between the central server, central controller, or remote host and the EGM (or personal computing device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal computing device). Further, one, more than one, or each of the functions of the at least one processor of the EGM (or personal computing device) may be performed by the at least one processor of the central server, central controller, or remote host.

In certain such embodiments, computerized instructions for controlling any games (such as any primary or base games and/or any secondary or bonus games) displayed by the EGM (or personal computing device) are executed by the central server, central controller, or remote host. In such “thin client” embodiments, the central server, central controller, or remote host remotely controls any games (or other suitable interfaces) displayed by the EGM (or personal computing device), and the EGM (or personal computing device) is utilized to display such games (or suitable interfaces) and to receive one or more inputs or commands. In other such embodiments, computerized instructions for controlling any games displayed by the EGM (or personal computing device) are communicated from the central server, central controller, or remote host to the EGM (or personal computing device) and are stored in at least one memory device of the EGM (or personal computing device). In such “thick client” embodiments, the at least one processor of the EGM (or personal computing device) executes the computerized instructions to control any games (or other suitable interfaces) displayed by the EGM (or personal computing device).

In various embodiments in which the gaming system includes a plurality of EGMs (or personal computing devices), one or more of the EGMs (or personal computing devices) are thin client EGMs (or personal computing devices) and one or more of the EGMs (or personal computing devices) are thick client EGMs (or personal computing devices). In other embodiments in which the gaming system includes one or more EGMs (or personal computing devices), certain functions of one or more of the EGMs (or personal computing devices) are implemented in a thin client environment, and certain other functions of one or more of the EGMs (or personal computing devices) are implemented in a thick client environment. In one such embodiment in which the gaming system includes an EGM (or personal computing device) and a central server, central controller, or remote host, computerized instructions for controlling any primary or base games displayed by the EGM (or personal computing device) are communicated from the central server, central controller, or remote host to the EGM (or personal computing device) in a thick client configuration, and computerized instructions for controlling any secondary or bonus games or other functions displayed by the EGM (or personal computing device) are executed by the central server, central controller, or remote host in a thin client configuration.

In certain embodiments in which the gaming system includes: (a) an EGM (or personal computing device) configured to communicate with a central server, central controller, or remote host through a data network; and/or (b) a plurality of EGMs (or personal computing devices) configured to communicate with one another through a data network, the data network is a local area network (LAN) in which the EGMs (or personal computing devices) are located substantially proximate to one another and/or the central server, central controller, or remote host. In one example, the EGMs (or personal computing devices) and the central server, central controller, or remote host are located in a gaming establishment or a portion of a gaming establishment.

In other embodiments in which the gaming system includes: (a) an EGM (or personal computing device) configured to communicate with a central server, central controller, or remote host through a data network; and/or (b) a plurality of EGMs (or personal computing devices) configured to communicate with one another through a data network, the data network is a wide area network (WAN) in which one or more of the EGMs (or personal computing devices) are not necessarily located substantially proximate to another one of the EGMs (or personal computing devices) and/or the central server, central controller, or remote host. For example, one or more of the EGMs (or personal computing devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal computing devices) are located. In certain embodiments in which the data network is a WAN, the gaming system includes a central server, central controller, or remote host and an EGM (or personal computing device) each located in a different gaming establishment in a same geographic area, such as a same city or a same state. Gaming systems in which the data network is a WAN are substantially identical to gaming systems in which the data network is a LAN, though the quantity of EGMs (or personal computing devices) in such gaming systems may vary relative to one another.

In further embodiments in which the gaming system includes: (a) an EGM (or personal computing device) configured to communicate with a central server, central controller, or remote host through a data network; and/or (b) a plurality of EGMs (or personal computing devices) configured to communicate with one another through a data network, the data network is an internet (such as the Internet) or an intranet. In certain such embodiments, an Internet browser of the EGM (or personal computing device) is usable to access an Internet game page from any location where an Internet connection is available. In one such embodiment, after the EGM (or personal computing device) accesses the Internet game page, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. The central server, central controller, or remote host may, however, identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM (or personal computing device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal computing device). Examples of implementations of Internet-based gaming are further described in U.S. Pat. No. 8,764,566, entitled “Internet Remote Game Server,” and U.S. Pat. No. 8,147,334, entitled “Universal Game Server,” which are incorporated herein by reference.

The central server, central controller, or remote host and the EGM (or personal computing device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal computing devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

### 5. EGM Components

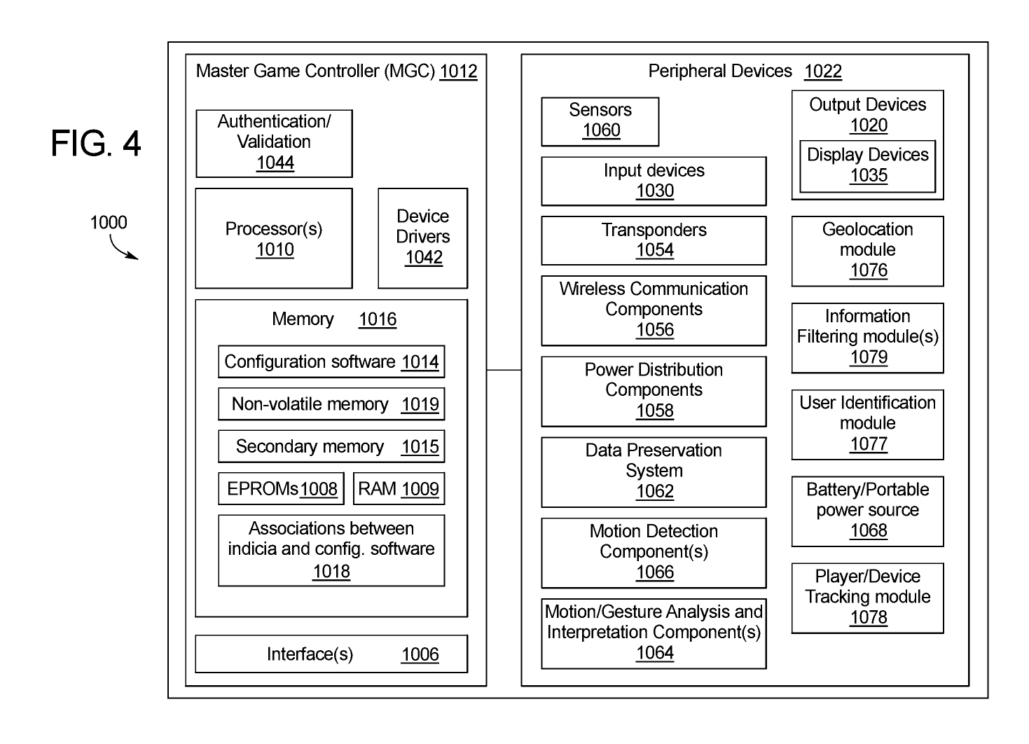

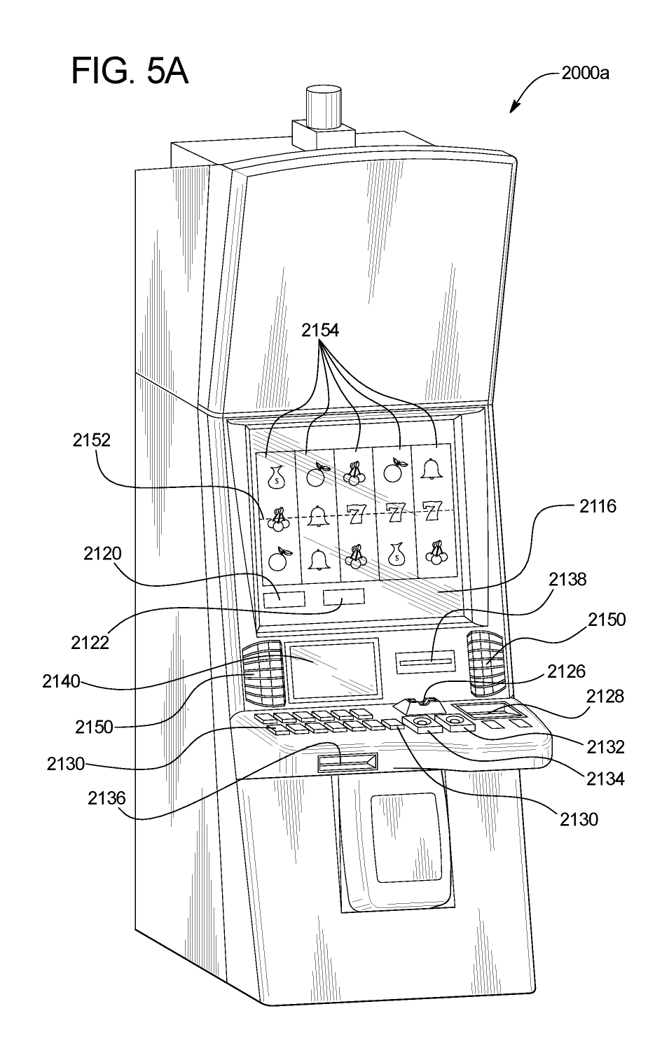

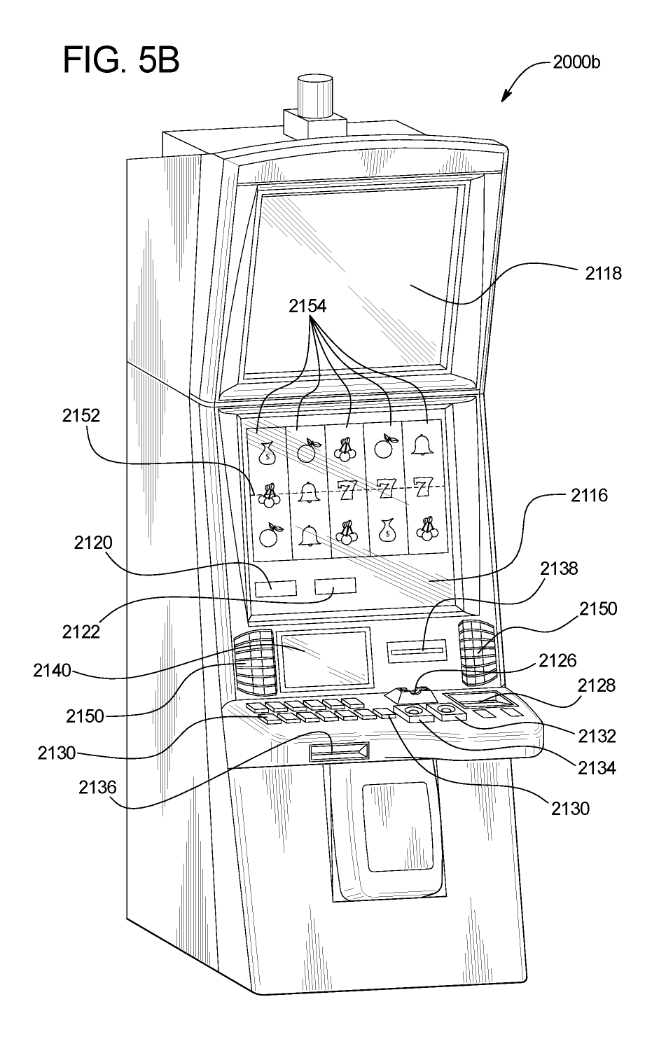

FIG. 4 is a block diagram of an example EGM 1000 and FIGS. 5A and 5B include two different example EGMs 2000a and 2000b. The EGMs 1000, 2000a, and 2000b are merely example EGMs, and different EGMs may be implemented using different combinations of the components shown in the EGMs 1000, 2000a, and 2000b.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM disclosed herein. In certain embodiments, the at least one memory device 1016 resides within the housing of the EGM (described below), while in other embodiments at least one component of the at least one memory device 1016 resides outside of the housing of the EGM.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc. Examples of various authentication and/or validation components are described in U.S. Pat. No. 6,620,047, entitled “Electronic Gaming Apparatus Having Authentication Data Sets,” which is incorporated herein by reference.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 5A includes a central display device 2116, a player tracking display 2140, a credit display 2120, and a bet display 2122. The example EGM 2000b illustrated in FIG. 5B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136. Examples of ticket-in ticket-out (TITO) technology are described in U.S. Pat. No. 5,429,361, entitled “Gaming Machine Information, Communication and Display System”; U.S. Pat. No. 5,470,079, entitled “Gaming Machine Accounting and Monitoring System”; U.S. Pat. No. 5,265,874, entitled “Cashless Gaming Apparatus and Method”; U.S. Pat. No. 6,729,957, entitled “Gaming Method and Host Computer with Ticket-In/Ticket-Out Capability”; U.S. Pat. No. 6,729,958, entitled “Gaming System with Ticket-In/Ticket-Out Capability”; U.S. Pat. No. 6,736,725, entitled “Gaming Method and Host Computer with Ticket-In/Ticket-Out Capability”; U.S. Pat. No. 7,275,991, entitled “Slot Machine with Ticket-In/Ticket-Out Capability”; U.S. Pat. No. 6,048,269, entitled “Coinless Slot Machine System and Method”; and U.S. Pat. No. 5,290,003, entitled “Gaming Machine and Coupons,” which are incorporated herein by reference.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player. Examples of providing payment using virtual tickets are described in U.S. Pat. No. 8,613,659, entitled “Virtual Ticket-In and Ticket-Out on a Gaming Machine,” which is incorporated herein by reference.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. Examples of funding an EGM via communication between the EGM and a mobile device (such as a mobile phone) of a player are described in U.S. Patent Application Publication No. 2013/0344942, entitled “Avatar as Security Measure for Mobile Device Use with Electronic Gaming Machine,” which is incorporated herein by reference. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices. U.S. Pat. No. 7,290,072 describes a variety of EGMs including one or more communication ports that enable the EGMs to communicate and operate with one or more external peripherals.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all gaming systems, and these example EGMs may not include one or more elements that are included in other gaming systems. For example, certain EGMs include a coin acceptor while others do not.

6. Operation of Primary or Base Games and/or Secondary or Bonus Games

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM prior to delivery to a gaming establishment or prior to being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award. Examples of this type of award evaluation are described in U.S. Pat. No. 7,470,183, entitled “Finite Pool Gaming Method and Apparatus”; U.S. Pat. No. 7,563,163, entitled “Gaming Device Including Outcome Pools for Providing Game Outcomes”; U.S. Pat. No. 7,833,092, entitled “Method and System for Compensating for Player Choice in a Game of Chance”; U.S. Pat. No. 8,070,579, entitled “Bingo System with Downloadable Common Patterns”; and U.S. Pat. No. 8,398,472, entitled “Central Determination Poker Game,” which are incorporated herein by reference.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. Examples of this type of award determination are described in U.S. Pat. No. 7,753,774, entitled “Using Multiple Bingo Cards to Represent Multiple Slot Paylines and Other Class III Game Options”; U.S. Pat. No. 7,731,581, entitled “Multi-Player Bingo Game with Multiple Alternative Outcome Displays”; U.S. Pat. No. 7,955,170, entitled “Providing Non-Bingo Outcomes for a Bingo Game”; U.S. Pat. No. 8,070,579, entitled “Bingo System with Downloadable Common Patterns”; and U.S. Pat. No. 8,500,538, entitled “Bingo Gaming System and Method for Providing Multiple Outcomes from Single Bingo Pattern,” which are incorporated herein by reference.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database configured to store player profiles, (b) a player tracking module configured to track players (as described below), and (c) a credit system configured to provide automated transactions. Examples of such accounting systems are described in U.S. Pat. No. 6,913,534, entitled “Gaming Machine Having a Lottery Game and Capability for Integration with Gaming Device Accounting System and Player Tracking System,” and U.S. Pat. No. 8,597,116, entitled “Virtual Player Tracking and Related Services,” which are incorporated herein by reference.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGM 2000b shown in FIG. 5B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. Examples of ways to win award determinations are described in U.S. Pat. No. 8,012,011, entitled “Gaming Device and Method Having Independent Reels and Multiple Ways of Winning”; U.S. Pat. No. 8,241,104, entitled “Gaming Device and Method Having Designated Rules for Determining Ways To Win”; and U.S. Pat. No. 8,430,739, entitled “Gaming System and Method Having Wager Dependent Different Symbol Evaluations,” which are incorporated herein by reference.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award. Examples of progressive gaming systems are described in U.S. Pat. No. 7,585,223, entitled “Server Based Gaming System Having Multiple Progressive Awards”; U.S. Pat. No. 7,651,392, entitled “Gaming Device System Having Partial Progressive Payout”; U.S. Pat. No. 7,666,093, entitled “Gaming Method and Device Involving Progressive Wagers”; U.S. Pat. No. 7,780,523, entitled “Server Based Gaming System Having Multiple Progressive Awards”; and U.S. Pat. No. 8,337,298, entitled “Gaming Device Having Multiple Different Types of Progressive Awards,” which are incorporated herein by reference

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards. Examples of group gaming systems are described in U.S. Pat. No. 8,070,583, entitled “Server Based Gaming System and Method for Selectively Providing One or More Different Tournaments”; U.S. Pat. No. 8,500,548, entitled “Gaming System and Method for Providing Team Progressive Awards”; and U.S. Pat. No. 8,562,423, entitled “Method and Apparatus for Rewarding Multiple Game Players for a Single Win,” which are incorporated herein by reference.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a mobile phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. Examples of player tracking systems are described in U.S. Pat. No. 6,722,985, entitled “Universal Player Tracking System”; U.S. Pat. No. 6,908,387, entitled “Player Tracking Communication Mechanisms in a Gaming Machine”; U.S. Pat. No. 7,311,605, entitled “Player Tracking Assembly for Complete Patron Tracking for Both Gaming and Non-Gaming Casino Activity”; U.S. Pat. No. 7,611,411, entitled “Player Tracking Instruments Having Multiple Communication Modes”; U.S. Pat. No. 7,617,151, entitled “Alternative Player Tracking Techniques”; and U.S. Pat. No. 8,057,298, entitled “Virtual Player Tracking and Related Services,” which are incorporated herein by reference.

7. Differentiating Certain Gaming Systems from General Purpose Computing Devices

Certain of the gaming systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code. Examples of EGM code authentication are described in U.S. Pat. No. 6,962,530, entitled “Authentication in a Secure Computerized Gaming System”; U.S. Pat. No. 7,043,641, entitled “Encryption in a Secure Computerized Gaming System”; U.S. Pat. No. 7,201,662, entitled “Method and Apparatus for Software Authentication”; and U.S. Pat. No. 8,627,097, entitled “System and Method Enabling Parallel Processing of Hash Functions Using Authentication Checkpoint Hashes,” which are incorporated herein by reference.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just prior to the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just prior to when the malfunction occurred. The restored state may include metering information and graphical information that was displayed on the EGM in the state prior to the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just prior to the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM prior to, during, and/or after the disputed game to demonstrate whether the player was correct or not in her assertion. Examples of a state-based EGM, recovery from malfunctions, and game history are described in U.S. Pat. No. 6,804,763, entitled “High Performance Battery Backed RAM Interface”; U.S. Pat. No. 6,863,608, entitled “Frame Capture of Actual Game Play”; U.S. Pat. No. 7,111,141, entitled “Dynamic NV-RAM”; and U.S. Pat. No. 7,384,339, entitled, “Frame Capture of Actual Game Play,” which are incorporated herein by reference.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives. Examples of trusted memory devices are described in U.S. Pat. No. 6,685,567, entitled “Process Verification,” which is incorporated herein by reference.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected. Examples of trusted memory devices/sources are described in U.S. Pat. No. 7,515,718, entitled “Secured Virtual Network in a Gaming Environment,” which is incorporated herein by reference.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present. Examples of using a mass storage device are described in U.S. Pat. No. 6,149,522, entitled “Method of Authenticating Game Data Sets in an Electronic Casino Gaming System,” which is incorporated herein by reference.

Various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
at least one display device;
at least one input device;
at least one processor; and
at least one memory device that stores a plurality of instructions that, when executed by the at least one processor, cause the at least one processor to operate with the at least one display device and the at least one input device to:
(a) initiate a play of a game associated with a plurality of different objects, at least one of the objects having an activatable gameplay-altering feature;
(b) display an obstacle and award area including multiple obstacles and multiple awards;
(c) pick an object from a player set of one or more of the objects;
(d) introduce the picked object into the obstacle and award area and display the object moving through the obstacle and award area in accordance with any active gameplay-altering features;
(e) responsive to an occurrence of an award event, provide an award;
(f) if the picked object has an activatable gameplay-altering feature, responsive to an occurrence of an activation event, activate that gameplay-altering feature; and
(g) responsive to an occurrence of an exit event, remove the picked object from the obstacle and award area.

2. The gaming system of claim 1, wherein the award event occurs responsive to the picked object colliding with one of the awards in the obstacle and award area.

3. The gaming system of claim 1, wherein the plurality of instructions, when executed by the at least one processor, cause the at least one processor to the object responsive to a player selection of the object from the player set of the objects.

4. The gaming system of claim 1, wherein the activation event occurs based on the picked object's movement through the obstacle and award area.

5. The gaming system of claim 1, wherein the activation event occurs responsive to a player input.

6. The gaming system of claim 1, wherein the player set of the objects includes two or more objects, and wherein the plurality of instructions, when executed by the at least one processor, cause the at least one processor to operate with the at least one display device to repeat (c) to (g) for each object in the player set of the objects.

7. The gaming system of claim 1, wherein the falling-object game is a bonus game, and wherein the plurality of instructions, when executed by the at least one processor, cause the at least one processor to operate with the at least one display device and the at least one input device to enable the player to collect objects for the player set via play of a primary game.

8. The gaming system of claim 7, wherein the plurality of instructions, when executed by the at least one processor, cause the at least one processor to initiate the play of the falling-object game responsive to an occurrence of a bonus triggering event in association with a play of the primary game.

9. The gaming system of claim 1, wherein one of the objects has a gameplay-altering feature that is active upon the object being introduced into the obstacle and award area.

10. A method of operating a gaming system, the method comprising:
(a) initiating, by at least one processor, a play of a game associated with a plurality of different objects, at least one of the objects having an activatable gameplay-altering feature;
(b) displaying, by at least one display device, an obstacle and award area including multiple obstacles and multiple awards;
(c) picking, by the at least one processor, an object from a player set of one or more of the objects;
(d) introducing, by the at least one processor, the picked object into the obstacle and award area and displaying, by the at least one display device, the object moving through the obstacle and award area in accordance with any active gameplay-altering features;
(e) responsive to an occurrence of an award event, providing an award;
(f) if the picked object has an activatable gameplay-altering feature, responsive to an occurrence of an activation event, activating, by the at least one processor, that gameplay-altering feature; and
(g) responsive to an occurrence of an exit event, removing, by the at least one processor, the picked object from the obstacle and award area.

11. The method of claim 10, wherein the award event occurs responsive to the picked object colliding with one of the awards in the obstacle and award area.

12. The method of claim 10, which includes picking the object responsive to a player selection of the object from the player set of the objects.

13. The method of claim 10, wherein the activation event occurs based on the picked object's movement through the obstacle and award area.

14. The method of claim 10, wherein the activation event occurs responsive to a player input.

15. The method of claim 10, wherein the player set of the objects includes two or more objects, and which includes repeating (c) to (g) for each object in the player set of the objects.

16. The method of claim 10, wherein the falling-object game is a bonus game, and which includes enabling the player to collect objects for the player set via play of a primary game.

17. The method of claim 16, which includes initiating, by the at least one processor, the play of the falling-object game responsive to an occurrence of a bonus triggering event in association with a play of the primary game.

18. The method of claim 10, wherein one of the objects has a gameplay-altering feature that is active upon the object being introduced into the obstacle and award area.

19. The method of claim 10, which is at least partially provided through a data network.

20. The method of claim 19, wherein the data network is an internet.
